(19) United States
(12) Patent Application Publication
(10) Pub. No.: US 2025/0342220 A1
(43) Pub. Date: Nov. 6, 2025

(54) DEVICE AND METHOD THEREOF FOR MONITORING CLOUD-BASED ELECTRONIC DETONATORS

(71) Applicant: HANWHA CORPORATION, Seoul (KR)

(72) Inventors: Dong Hee Lee, Seongnam-si, Gyeonggi-do (KR); Yong Seok Kuk, Seongnam-si, Gyeonggi-do (KR); Jun Pil Lee, Seongnam-si, Gyeonggi-do (KR)

(73) Assignee: HANWHA CORPORATION, Seoul (KR)

(21) Appl. No.: 18/696,824

(22) PCT Filed: Oct. 25, 2022
(86) PCT No.: PCT/KR2022/016363

§ 371 Date: Oct. 25, 2024

(30) Foreign Application Priority Data
Oct. 25, 2022 (KR) 10-2022-0138014

(51) Int. Cl. G06F 16/958; F42C 21/00; G06F 16/909

(52) U.S. Cl. CPC G06F 16/958; G06F 16/909; F42C 21/00

(57) ABSTRACT

A device and a method thereof for monitoring cloud-based electronic detonators are proposed. The device includes: a terminal location information transmission unit configured to collect location information of a terminal, and transmit the location information to a cloud service, an on-site information provision unit configured to download design information, and provide on-site information obtained by overlaying the downloaded design information and on-site images that are collected through a camera of the terminal by the worker, an electronic detonator information transmission unit configured to transmit input information of a plurality of electronic detonators to the cloud service when the worker inputs, through the terminal, the information of the plurality of electronic detonators collected on the basis of the provided on-site information, and an electronic detonator state transmission unit configured to collect state information of each electronic detonator, and transmit the state information to the cloud service.

### TECHNICAL FIELD

The present disclosure relates to a device and a method thereof for monitoring cloud-based electronic detonators and, more particularly, to a device and a method thereof for monitoring cloud-based electronic detonators, wherein, by combining a conventional electronic detonator blasting system with on-site digitalization technology, a manager may check, online in real time, electronic detonator equipment and positions, states, and work rates of detonators, and a worker may use a wearable device at a work site to check, in real time, information on the work site where blasting work is conducted.

### BACKGROUND ART

A conventional electronic detonator blasting system has many limitations in real-time monitoring of work rates, equipment locations, and work sites by using blasting equipment or a local network.

In a case of an open-air site, real-time location tracking or work data sharing is difficult due to limitations in equipment functions or constraints in a communication environment. In addition, due to characteristics of a blasting system for detonating high-performance explosives, in the case of the conventional blasting system in terms of safety management, information, including not only logistics information such as warehousing and usage amounts but also up to product states in use, is managed by handwriting input or a method of aggregation after blasting is completed.

That is, in the related art, there is a problem in that a process of comparing/checking the blasting information with a separate plan is required for a worker to check blasting information at a work site, and an additional checking work procedure is required to check a detonator state for detonation.

In this regard, Korean Patent Application Publication No. 2021-0073332 discloses “APPARATUS AND METHOD FOR MANAGING REGISTRATION AND PLACEMENT OF DETONATOR”.

### DISCLOSURE

### Technical Problem

The present disclosure is devised to solve the above problem, and an objective of the present disclosure is to provide a device and a method thereof for monitoring cloud-based electronic detonators, wherein, when a worker connects to and logs in a preset web page through a terminal possessed by himself or herself, location information of the corresponding terminal is collected and transmitted to a cloud service.

In addition, another objective of the present disclosure is to provide a device and a method thereof for monitoring cloud-based electronic detonators, wherein, when a worker requests downloading of design information provided from a web page through a terminal, the design information is downloaded, and on-site information obtained by overlaying the downloaded design information and on-site images that are collected through a camera of the terminal by the worker is provided.

In addition, a yet another objective of the present disclosure is to provide a device and a method thereof for monitoring cloud-based electronic detonators, wherein, when a worker inputs, through a terminal, information of a plurality of electronic detonators collected on the basis of provided on-site information, the input information of the plurality of electronic detonators is transmitted to a cloud service.

In addition, a still another objective of the present disclosure is to provide a device and a method thereof for monitoring cloud-based electronic detonators, wherein, when communication tests between a plurality of electronic detonators and a terminal are completed, state information of each electronic detonator is collected and transmitted to a cloud service.

### Technical Solution

According to the present disclosure for achieving the above objectives, there is provided a device for monitoring cloud-based electronic detonators, the device including: a terminal location information transmission unit configured to collect location information of a terminal when a worker connects to and logs in a preset web page through the corresponding terminal possessed by the worker, and transmit the location information to a cloud service; an on-site information provision unit configured to download design information when the worker requests downloading of the design information provided from the web page through the terminal, and provide on-site information obtained by overlaying the downloaded design information and on-site images that are collected through a camera of the terminal by the worker; an electronic detonator information transmission unit configured to transmit input information of a plurality of electronic detonators to the cloud service when the worker inputs, through the terminal, the information of the plurality of electronic detonators collected on the basis of the provided on-site information; and an electronic detonator state transmission unit configured to collect state information of each electronic detonator when communication tests between the plurality of electronic detonators and the terminal are completed, and transmit the state information to the cloud service.

In addition, the terminal location information transmission unit may collect the location information of the corresponding terminal at a preset interval to transmit the location information to the cloud service, but display the collected location information of the terminal on a map of the connected web page.

In addition, the on-site information provision unit may download the design information to the terminal through the web page, and realize, as Augmented Reality (AR), the on-site information obtained by overlaying the downloaded design information and the collected on-site images, so as to provide the Augmented Reality (AR) to the worker through the terminal.

In addition, the electronic detonator information transmission unit may transmit the electronic detonator information including at least any one of electronic detonator IDs, detonation times in milliseconds, and quantities to the cloud service, but display the collected information of the plurality of electronic detonators on a map of the connected web page.

In addition, the electronic detonator state transmission unit may realize the collected state information of the plurality of electronic detonators in the connected web page, and provide the collected state information of the plurality of electronic detonators to the worker through the terminal.

In addition, the device may further include a blasting machine location information transmission unit configured to collect the location information of a blasting machine when the corresponding blasting machine for electronic detonator detonation is connected to and logged in the preset web page through the network, and display the collected location information of the blasting machine on a map of the connected web page.

In addition, the device may further include a test progress result collection unit configured to collect test progress results when the communication tests between the plurality of electronic detonators and the blasting machine are completed, and display the collected test progress results on the connected web page.

In addition, the device may further include a charging work progress result collection unit configured to collect charging work progress results when the electronic detonator charging work for detonation is in progress in the blasting machine, and display the collected charging work progress results on the connected web page.

In addition, the device may further include a blasting result report upload unit configured to receive a transmitted blasting result report generated by the blasting machine after the electronic detonator blasting is completed, and upload the blasting result report to the connected web page.

According to the present disclosure for achieving the above objectives, there is provided a method for monitoring cloud-based electronic detonators, the method including: collecting, by a terminal location information transmission unit, location information of a terminal when a worker connects to and logs in a preset web page through the corresponding terminal possessed by the worker, and transmitting the location information to a cloud service; downloading, by an on-site information provision unit, design information when the worker requests downloading of the design information provided from the web page through the terminal, and providing on-site information obtained by overlaying the downloaded design information and on-site images that are collected through a camera of the terminal by the worker; transmitting, by an electronic detonator information transmission unit, input information of a plurality of electronic detonators to the cloud service when the worker inputs, through the terminal, the information of the plurality of electronic detonators collected on the basis of the provided on-site information; and collecting, by an electronic detonator state transmission unit, state information of each electronic detonator when communication tests between the plurality of electronic detonators and the terminal are completed, and transmitting the state information to the cloud service.

In addition, the method may further include: collecting, by a blasting machine location information transmission unit, the location information of a blasting machine when the corresponding blasting machine for electronic detonator detonation is connected to and logged in the preset web page through the network, and displaying the collected location information of the blasting machine on a map of the connected web page; collecting, by a test progress result collection unit, test progress results when the communication tests between the plurality of electronic detonators and the blasting machine are completed, and displaying the collected test progress results on the connected web page; and collecting, by a charging work progress result collection unit, charging work progress results when the electronic detonator charging work for detonation is in progress in the blasting machine, and displaying the collected charging work progress results on the connected web page.

### Advantageous Effects

According to the present disclosure for achieving the objectives, in the device and the method thereof for monitoring the cloud-based electronic detonators, there is an effect that when the worker connects to and logs in the preset web page through the terminal, the location information of the corresponding terminal is collected and transmitted to the cloud service, whereby only a specific person to whom authority has been granted may monitor the information, and real-time data between the blasting machine and the web page may be transmitted and received through an online network installed in the site.

In addition, in the present disclosure, there is another effect that when the worker requests the downloading of the design information provided from the web page through the terminal, the design information is downloaded, and the on-site information obtained by overlaying the downloaded design information and the on-site images that are collected through the camera of the terminal by the worker is provided, whereby the worker may be able to check, in real time, the information on the site where the blasting work is conducted and may determine the states of the electronic detonators used for the detonation.

In addition, in the present disclosure, there is a yet another effect that when the worker inputs, through the terminal, the information of the plurality of electronic detonators collected on the basis of the provided on-site information, the input information of the plurality of electronic detonators is transmitted to the cloud service, whereby the manager may determine the on-site work rates and the information of the blasting equipment in real time.

As such, in the present disclosure, there are still other effects that the security and safety of the blasting work may be strengthened through the real-time sharing of the locations and states of the equipment, and the on-site information and the detonation detonator information are shared, whereby the work safety and efficiency of each worker may be increased through alarms for dangerous areas or unexpected on-site changes.

### DESCRIPTION OF DRAWINGS

FIG. 1 is a view illustrating a configuration of a system to which a device for monitoring cloud-based electronic detonators according to the present disclosure is applied.

FIG. 2 is a view illustrating a configuration of the device for monitoring the cloud-based electronic detonators according to the present disclosure.

FIGS. 3 and 4 are views illustrating respective sequences of a method for monitoring cloud-based electronic detonators according to the present disclosure.

### BEST MODE

In the present disclosure, various modifications may be made and various exemplary embodiments may be provided, and specific exemplary embodiments will be illustrated in the drawings and described in detail.

However, this is not intended to limit the present disclosure to a particular embodied form. On the contrary, the present disclosure is to be understood to include all various alternatives, equivalents, and substitutes that may be included within the spirit and technical scope of the present disclosure. While describing each drawing, similar reference numerals have been used for similar components.

It will be understood that when a component is referred to as being “coupled” or “connected” to another component, it can be directly coupled or connected to the other component or intervening components may be present. In contrast, when a component is described as being “directly coupled”, “directly connected”, or “directly linked” to another component, it should be understood that there are no intervening components present therebetween.

The terminology used herein is for the purpose of describing particular exemplary embodiments only and is not intended to be limiting. As used herein, the singular forms are intended to include the plural forms as well, unless the context clearly indicates otherwise. In addition, it will be further understood that the terms “comprise”, “include”, “have”, etc. when used in the present application, specify the presence of stated features, integers, steps, operations, elements, components, and/or combinations of them but do not preclude the possibility of the presence or addition of one or more other features, integers, steps, operations, elements, components, and/or combinations thereof.

Hereinafter, preferred exemplary embodiments of the present disclosure will be described in more detail with reference to the accompanying drawings. Hereinafter, the same reference numerals are used for the same components in the drawings, and duplicated descriptions for the same components are omitted.

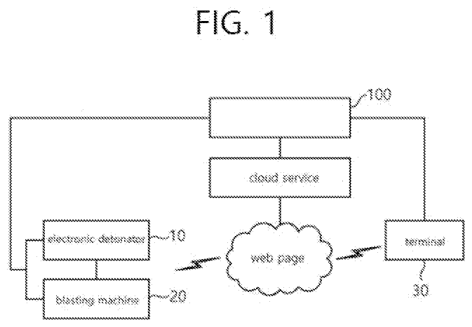

FIG. 1 is a view illustrating a configuration of a system to which a device for monitoring cloud-based electronic detonators according to the present disclosure is applied.

Describing with reference to FIG. 1, the system to which the device 100 for monitoring the cloud-based electronic detonators according to the present disclosure is applied may be largely configured to include each electronic detonator, a blasting machine, and a terminal.

The electronic detonators 10 proceed blasting by using electronic detonators controlled by respective electronic chips in a blasting area. The electronic detonators may precisely control respective explosion times in units of 1/1000 of a second, and explosives may also be blasted wirelessly.

The blasting machine 20 is an ignition device used to ignite the explosives.

In addition, in the present disclosure, an online network is essential in a site. By applying HATS' EagleFinenet or a site-owned base station, each device connects to a specific web page and transmits real-time data through WiFi at a work site. The terminal 30 is a device for collecting electronic detonator IDs and inputting detonation times in milliseconds, and is provided in a wearable form that can be carried by a worker.

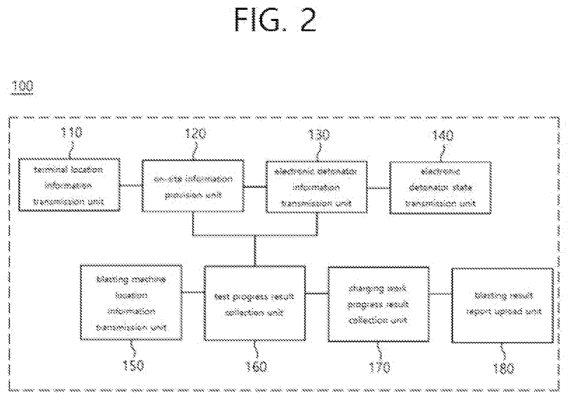

The device 100 for monitoring the cloud-based electronic detonators combines the conventional electronic detonator blasting system and on-site digitization technology, so as to enable the manager to check the locations, states, and work rates of the electronic detonator equipment and electronic detonators online in real time, and enable the worker to determine the information of the on-site electronic detonators on the basis of the locations. The corresponding configurations and functions according to the above description will be described in detail later with reference to FIG. 2.

FIG. 2 is a view illustrating the configuration of the device for monitoring the cloud-based electronic detonators according to the present disclosure.

Describing with reference to FIG. 2, the device 100 for monitoring the cloud-based electronic detonators according to the present disclosure may largely include a terminal location information transmission unit 110, an on-site information provision unit 120, an electronic detonator information transmission unit 130, electronic an detonator state transmission unit 140, a blasting machine location information transmission unit 150, a test progress result collection unit 160, a charging work progress result collection unit 170, and a blasting result report upload unit 180.

The terminal location information transmission unit 110 collects location information of a terminal when a worker connects to and logs in a preset web page through the corresponding terminal possessed by himself or herself, and transmits the location information to a cloud service.

The terminal location information transmission unit 110 collects the location information of the corresponding terminal at a preset interval and transmits the location information to the cloud service, but displays the collected location information of the terminal on a map of the connected web page.

The on-site information provision unit 120 downloads design information when the worker requests downloading of the design information provided from the web page through the terminal, and provides on-site information obtained by overlaying the downloaded design information and on-site images that are collected through a camera of the terminal by the worker.

The on-site information provision unit 120 may provide Augmented Reality (AR) to the worker through the terminal by downloading the design information to the terminal through the web page and realizing, as the Augmented Reality (AR), the on-site information obtained by overlaying the downloaded design information and the collected on-site images.

The electronic detonator information transmission unit 130 transmits input information of a plurality of electronic detonators to the cloud service when the worker inputs, through the terminal, the information of the plurality of electronic detonators collected on the basis of the provided on-site information.

The electronic detonator information transmission unit 130 transmits the electronic detonator information, including at least any one of electronic detonator IDs, detonation times in milliseconds, and quantities, to the cloud service, but displays the collected information of the plurality of electronic detonators on a map of the connected web page. In this way, the manager is able to check an on-site work rate and information of a blasting machine in real time.

The electronic detonator state transmission unit 140 collects state information of each electronic detonator when communication tests between the plurality of electronic detonators and the terminal are completed, and transmits the state information to the cloud service.

After wiring and the communication tests of the electronic detonators are completed at the work site, the electronic detonator state transmission unit 140 may realize the collected state information of the plurality of electronic detonators into the connected web page, and provide the collected state information of the plurality of electronic detonators to the worker through the terminal. Here, the state information of the plurality of electronic detonators is displayed on the terminal, and the worker may check the information of the electronic detonators used in the site on the basis of locations.

The blasting machine location information transmission unit 150 collects location information of the blasting machine when the corresponding blasting machine for electronic detonator detonation is connected to and logged in the preset web page through the network, and displays the collected location information of the blasting machine on the map of the connected web page.

The blasting machine location information transmission unit 150 may receive electronic detonator information and on-site information, which are collected in the site from the worker's terminal, when the login is completed.

The test progress result collection unit 160 collects test progress results when the communication tests between the plurality of electronic detonators and the blasting machine are completed, and displays the collected test progress results on the connected web page. Accordingly, the worker may check the test progress results based on the electronic detonator information, which is displayed on the terminal on the basis of the locations.

The charging work progress result collection unit 170 collects charging work progress results when the electronic detonator charging work for detonation is in progress in the blasting machine, and displays the collected charging work progress results on the connected web page.

The charging work progress result collection unit 170 displays guide notifications of the charging work progress results on the web page, and for example, “ready for blasting” may be displayed as a work procedure when the charging work is completed.

The blasting result report upload unit 180 receives a transmitted blasting result report generated by the blasting machine after the electronic detonator blasting is completed, and uploads the blasting result report to the connected web page. In this way, the manager may check details for each blasting site on the web page.

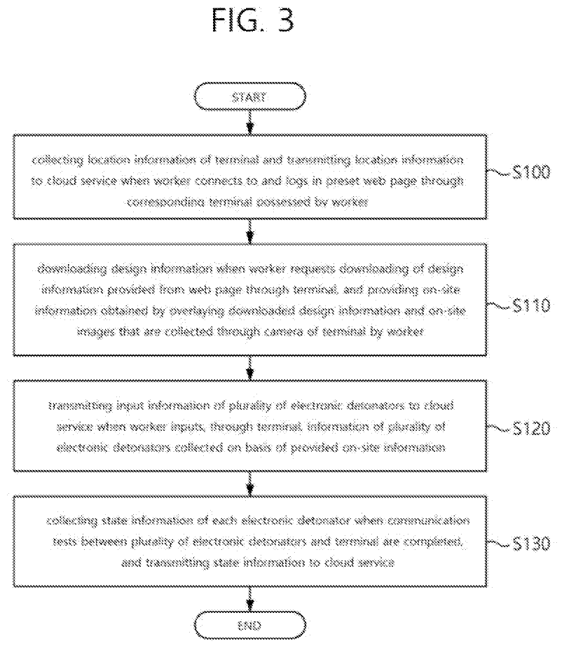

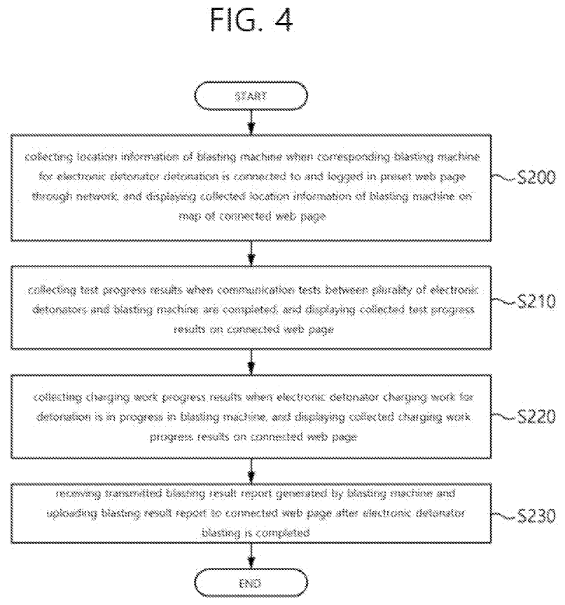

FIGS. 3 and 4 are views illustrating respective sequences of a method for monitoring cloud-based electronic detonators according to the present disclosure.

Describing with reference to FIGS. 3 and 4, the sequences of the method for monitoring the cloud-based electronic detonators according to the present disclosure is to use the device for monitoring the cloud-based electronic detonators according to the present disclosure described above, and hereinafter, duplicate description will be omitted.

FIG. 3 relates to a: of performing electronic detonator monitoring through a terminal possessed by a worker. First, in step S100, when the worker connects to and logs in a preset web page through the terminal possessed by himself or herself, location information of the corresponding terminal is collected and transmitted to a cloud service.

In step S100, the location information of the corresponding terminal is collected at a preset interval and transmitted to the cloud service, but the collected location information of the terminal is displayed on a map of the connected web page. Next, in step S110, when the worker requests downloading of design information provided from the web page through the terminal, the design information is downloaded, and on-site information obtained by overlaying the downloaded design information and on-site images that are collected through a camera of the terminal by the worker is provided.

In step S110, the design information is downloaded to the terminal through the web page, and the on-site information obtained by overlaying the downloaded design information and the collected on-site images is realized as Augmented Reality (AR), so that the Augmented Reality (AR) may be provided to the worker through the terminal.

Next, in step S120, when the worker inputs, through the terminal, information of a plurality of electronic detonators collected on the basis of the provided on-site information, the input information of the plurality of electronic detonators is transmitted to the cloud service.

In step S120, the electronic detonator information including at least any one of electronic detonator IDs, detonation times in milliseconds, and quantities is transmitted to the cloud service, but the collected information of the plurality of electronic detonators is displayed on the map of the connected web page. In this way, the manager may check an on-site work rate and information of a blasting machine in real time.

Next, in step S130, when communication tests between the plurality of electronic detonators and the terminal are completed, state information of each electronic detonator is collected and transmitted to the cloud service.

In step S130, after wiring and the communication tests of the electronic detonators are completed at the work site, the collected state information of the plurality of electronic detonators may be realized into the connected web page, and provided to the worker through the terminal. Here, the state information of the plurality of electronic detonators is displayed on the terminal, and the worker may check the information of the electronic detonators used in the site on the basis of locations.

FIG. 4 relates to a process of performing electronic detonator monitoring through a blasting machine for electronic detonator detonation. First, in step S200, location information of the corresponding blasting machine is collected when the blasting machine for the electronic detonator detonation is connected to and logged in a preset web page through a network, and the collected location information of the blasting machine is displayed on a map of the connected web page.

In step S200, when the login is completed, electronic detonator information and on-site information, which are collected in a site from a worker's terminal, may be received. Next, test progress results are collected when communication tests between the plurality of electronic detonators and the blasting machine are completed, and the collected test progress results are displayed on the connected web page. Accordingly, in step S210, the worker may check the test progress results based on the electronic detonator information displayed on the terminal on the basis of the locations.

Next, in step S220, charging work progress results are collected when electronic detonator charging work for detonation is in progress in the blasting machine, and the collected charging work progress results are displayed on the connected web page.

In step S220, guide notifications of the charging work progress results are displayed on the web page, and for example, “ready for blasting” may be displayed as a work procedure when the charging work is completed.

Next, in step S230, after the electronic detonator blasting is completed, the transmitted blasting result report generated by the blasting machine is received and uploaded to the connected web page.

1. A device for monitoring cloud-based electronic detonators, the device comprising:
a terminal location information transmission unit configured to collect location information of a terminal when a worker connects to and logs in a preset web page through the corresponding terminal possessed by the worker, and transmit the location information to a cloud service;
an on-site information provision unit configured to download design information when the worker requests downloading of the design information provided from the web page through the terminal, and provide on-site information obtained by overlaying the downloaded design information and on-site images that are collected through a camera of the terminal by the worker;
an electronic detonator information transmission unit configured to transmit input information of a plurality of electronic detonators to the cloud service when the worker inputs, through the terminal, the information of the plurality of electronic detonators collected on the basis of the provided on-site information; and
an electronic detonator state transmission unit configured to collect state information of each electronic detonator when communication between the plurality of electronic detonators and the terminal are completed, and transmit the state information to the cloud service.

2. The device of claim 1, wherein the terminal location information transmission unit collects the location information of the corresponding terminal at a preset interval to transmit the location information to the cloud service, but displays the collected location information of the terminal on a map of the connected web page.

3. The device of claim 1, wherein the on-site information provision unit downloads the design information to the terminal through the web page, and realizes, as Augmented Reality (AR), the on-site information obtained by overlaying the downloaded design information and the collected on-site images, so as to provide the Augmented Reality (AR) to the worker through the terminal.

4. The device of claim 1, wherein the electronic detonator information transmission unit transmits the electronic detonator information including at least any one of electronic detonator IDs, detonation times in milliseconds, and quantities to the cloud service, but displays the collected information of the plurality of electronic detonators on a map of the connected web page.

5. The device of claim 1, wherein the electronic detonator state transmission unit realizes the collected state information of the plurality of electronic detonators in the connected web page, and provides the collected state information of the plurality of electronic detonators to the worker through the terminal.

6. The device of claim 1, further comprising:
a blasting machine location information transmission unit configured to collect the location information of a blasting machine when the corresponding blasting machine for electronic detonator detonation is connected to and logged in the preset web page through the network, and display the collected location information of the blasting machine on a map of the connected web page.

7. The device of claim 1, further comprising:
a test progress result collection unit configured to collect test progress results when the communication tests between the plurality of electronic detonators and the blasting machine are completed, and display the collected test progress results on the connected web page.

8. The device of claim 1, further comprising:
a charging work progress result collection unit configured to collect charging work progress results when the electronic detonator charging work for detonation is in progress in the blasting machine, and display the collected charging work progress results on the connected web page.

9. The device of claim 1, further comprising:
a blasting result report upload unit configured to receive a transmitted blasting result report generated by the blasting machine after the electronic detonator blasting is completed, and upload the blasting result report to the connected web page.

10. A method for monitoring cloud-based electronic detonators, the method comprising:
collecting, by a terminal location information transmission unit, location information of a terminal when a worker connects to and logs in a preset web page through the corresponding terminal possessed by the worker, and transmitting the location information to a cloud service;
downloading, by an on-site information provision unit, design information when the worker requests downloading of the design information provided from the web page through the terminal, and providing on-site information obtained by overlaying the downloaded design information and on-site images that are collected through a camera of the terminal by the worker;
transmitting, by an electronic detonator information transmission unit, input information of a plurality of electronic detonators to the cloud service when the worker inputs, through the terminal, the information of the plurality of electronic detonators collected on the basis of the provided on-site information; and
collecting, by an electronic detonator state transmission unit, state information of each electronic detonator when communication tests between the plurality of electronic detonators and the terminal are completed, and transmitting the state information to the cloud service.

11. The method of claim 10, further comprising:
collecting, by a blasting machine location information transmission unit, the location information of a blasting machine when the corresponding blasting machine for electronic detonator detonation is connected to and logged in the preset web page through the network, and displaying the collected location information of the blasting machine on a map of the connected web page;
collecting, by a test progress result collection unit, test progress results when the communication tests between the plurality of electronic detonators and the blasting machine are completed, and displaying the collected test progress results on the connected web page; and
collecting, by a charging work progress result collection unit, charging work progress results when the electronic detonator charging work for detonation is in progress in the blasting machine, and displaying the collected charging work progress results on the connected web page.
